(19) United States
(12) Patent Application Publication
(10) Pub. No.: US 2019/0298122 A1
(43) Pub. Date: Oct. 3, 2019

(54) BACKPACK DUST EXTRACTOR

(71) Applicant: MAKITA CORPORATION, Anjo-shi (JP)

(72) Inventors: Takayuki TAHARA, Anjo-shi (JP); Keisuke YAMADA, Anjo-shi (JP)

(21) Appl. No.: 16/298,136

(22) Filed: Mar. 11, 2019

(30) Foreign Application Priority Data
Mar. 30, 2018 (JP) 2018-067840
Jan. 16, 2019 (JP) 2019-005177

(51) Int. Cl. A47L 5/36; A47L 9/10

(52) U.S. Cl. CPC A47L 5/36; H04W 4/80; A47L 9/102

(57) ABSTRACT

A dust collector (dust extractor) (10) has a wireless communication unit (25; 30; 31; 32; 33; 34; 35; 36; 37) that remotely operates (controls) a dust-collection mechanism disposed in a main body (11) of the dust collector (10). The wireless communication unit of the dust collector (10) may communicate with a paired tool wireless-communication device (2b) associated with a tool (2) so that the dust-collection mechanism of the main body 11 is started and stopped in a linked manner with the starting and stopping of the tool (2), thereby improving ease of operation and work efficiency, because the dust collector (10) automatically turns on and off in coordination with operation of the tool (2).

### CROSS-REFERENCE

The present application claims priority to Japanese patent application serial number 2018-067840 filed on Mar. 30, 2018 and to Japanese patent application serial number 2019-5177 filed on Jan. 16, 2019, the contents of both of which are incorporated fully herein by reference.

### TECHNICAL FIELD

The present invention generally relates to a dust collection system (e.g., a backpack dust extractor or vacuum cleaning) for collecting (vacuuming, extracting) dust, chips, debris, etc. generated when, e.g., cutting a board using a cutting tool or drilling a hole.

### BACKGROUND ART

Dust is generated, e.g., when cutting board materials or drilling holes in concrete. To keep the work environment clean, the dust may be collected (vacuumed) using a dust collector (vacuum) while the dust is being generated (i.e. simultaneously) or soon thereafter (i.e. subsequently).

For example, as an example of simultaneous dust collection, Japanese Patent No. 4955332 discloses a rolling dust collector that is directly coupled to a dust-generating part (e.g., a tool accessory, such as a saw blade or drill bit) of a power tool, such as a disc grinder or a hammer drill, via a dust-collecting hose. In addition, Japanese Patent No. 4955332 discloses a technique for using wireless communication to start and stop the dust collector. More specifically, when the power tool is started, the dust collector is automatically activated (turned on) via wireless communication and begins to collect dust; furthermore, when the power tool is stopped, the dust collector likewise automatically stops. Consequently, because the user need only start and stop the power tool (and the dust collector automatically starts and stops in response thereto), work efficiency can be increased.

In the alternative, as an example of subsequent dust collection, Japanese Laid-open Patent Publication 2017-18567 and its family member US 2017/0007085 disclose a battery-powered dust collector (backpack dust extractor or vacuum cleaner) that is carried on the user's back via a shoulder harness. Therefore, the user may hold a power tool in his/her hand to perform various types of work while carrying the cordless dust collector on his/her back. As a result, work and clean up can be rapidly performed in sequence, i.e. with minimal interruption of the work, thereby enabling a wider range of work to be efficiently performed than by simultaneously cleaning up (vacuuming) using the dust collector of Japanese Patent No. 4955332, which must be rolled on the floor and has a power cord for supplying power from a commercial (mains) power source.

### SUMMARY OF THE INVENTION

However, the above-described, known dust collector (backpack dust extractor or vacuum cleaner) that is carried on the back has a dedicated (physical) switch to start and stop the dust collector and the dedicated switch must be manually operated to start and stop the dust collector, i.e. in addition to the starting and stopping of a power tool. Consequently, work efficiency suffers. In addition, because the dedicated switch is provided on a main body of the dust collector, which is behind the user when it is carried on the back, access to the dedicated switch is inconvenient. As a result, the user may be required to take the main body off his/her back to operate the switch, thereby further reducing work efficiency.

It is an object of the present teachings to make a dust collector (backpack dust extractor or vacuum cleaner), which is carried on one's back, easier to use and to operate (start/stop), thereby increasing working efficiency.

For example, in a first aspect of the present teachings, a dust collector (backpack dust extractor or vacuum cleaner) may comprise: a main body, wherein one end of a dust-collecting hose is connected thereto and the other end of the dust-collecting hose is connectable (attachable) to a power tool; a belt or harness adapted for carrying the main body on a user's back; and an operation unit for remotely operating the main body (e.g., an electric motor driving a fan, i.e. dust-collecting mechanism or a vacuum unit, disposed in the main body) and/or a wireless communication unit disposed, e.g., in the operating unit or on another portion of the dust collector, such as the main body or belt (harness), for transmitting operation commands to the main body (e.g., to start/stop an electric motor driving a fan, i.e. a vacuum unit, disposed in the main body). In the first aspect, starting and stopping of the main body (i.e. the dust-collection mechanism or vacuum unit therein) is linked, by wireless communication, to the starting and stopping of the power tool. In other words, the dust collector is wirelessly and automatically activated and deactivated in response to starting and stopping, respectively, of the operation of the power tool.

Therefore, the dust collector according to the first aspect can be carried on the user's back and need not be separately (i.e. additionally) started and stopped, thereby improving ease of operation and work efficiency. For example, a short-range, wireless communication standard (e.g., Bluetooth®) can be used as the wireless communication protocol/standard for wirelessly communicating with the power tool via the operation unit or wireless communication unit. In the first aspect, the dust collector optionally may be started simultaneously with the starting of the power tool, and the dust collector may be stopped, e.g., after the elapse of a prescribed (e.g., a predetermined (factory set) or user settable) time from the stoppage of the power tool. In such an embodiment, dust collection can be performed reliably, conveniently and efficiently.

In a second aspect of the present teachings, the wireless communication unit may be provided on a lower portion of the main body.

According to the second aspect, design freedom is ensured with regard to the location of the wireless communication unit while also ensuring that the wireless communication unit is arranged in a protective (durable) and dustproof location.

In a third aspect of the present teachings, the wireless communication unit may be provided on a front side or lateral side of the main body. The front side of the main body is the side that is opposite of the user's back when the dust collector is being carried on the user's back. The lateral sides of the main body are outer sides that intersect a plane containing the front side (or a portion thereof) of the main body.

According to the third aspect, the wireless communication unit can be placed in an easily reachable location when the main body is being carried on the user's back, because the wireless communication unit is provided on the side of the main body opposite of the user's back or on a lateral side.

In a fourth aspect of the present teachings, the wireless communication unit may be provided on the belt or harness.

According to the fourth aspect, the wireless communication unit is located on a portion of the dust collector that can be easily and conveniently reached during dust collection without diminishing work efficiency.

In a fifth aspect of the present teachings, the wireless communication unit may be provided on a shoulder belt or waist belt of the belt or harness.

According to the fifth aspect, the wireless communication unit can be easily reached by hand while performing dust collection.

In a sixth aspect of the present teachings, an adapter for performing wireless communication may be provided on or in (in electrical communication with) the wireless communication unit and/or in the operation unit. The adapter is optionally removably inserted into a slot or recess of the wireless communication unit so that it can be used with a plurality of power tools and/or dust collectors.

According to the sixth aspect, the signal-transmission path between the adapter for wireless communication and the wireless communication unit or the operation unit can be shortened, and thereby reliable signal transmission can be achieved. In addition or in the alternative, if the adapter is provided on or in the operation unit or the belt/harness, which are isolated (separated) from the main body (which tends to generate relatively strong vibration when the vacuum unit is operating), chattering (rattling) of the adapter, etc. can be prevented or minimized.

In a seventh aspect of the present teachings, the operation unit may have, e.g., a rectangular-box shape and may comprise, on its front surface, operation switches (e.g., buttons) for starting and stopping the dust-collection mechanism or vacuum unit disposed in the main body (e.g., an electric motor disposed therein that rotates a suction fan). Optionally, the adapter may be built into (inserted into) a side part of the operation unit that intersects the front surface of the operation unit in a longitudinal direction.

According to the seventh aspect of the invention, the adapter for wireless communication can be built-in (installed) without causing an increase in the size of the operation unit.

In an eighth aspect of the present teachings, the operation unit may have, e.g., a rectangular-box shape and may be operated by placing (holding) the operation unit on one's palm. In such an embodiment, a corner part on a near side of the side part, in which the adapter is installed (inserted), is omitted, e.g., the corner part is curved to receive the pinky finger of the hand holding the operation unit.

According to the eighth aspect, because the operation unit, which has an omitted (missing) corner part, can be securely and comfortably held in the palm, it is easy to operate, whereby ease of operation of the operation unit can be improved.

In a ninth aspect of the present teachings, the operation unit may be connected to the main body via a cord (electric cable) for electrical communication, e.g., to receive electric current for powering the operation and for wired communication of signals between the operation unit (i.e. a controller thereof) and a controller (e.g., a microprocessor or other electronic control circuit) disposed in the main body.

According to the ninth aspect, the transmission and reception of signals between the main body and the operation unit via the cord (electric cable) is not subject to interference from other electromagnetic waves, whereby reliability of the wired communication is improved.

In a tenth aspect of the present teachings, the target to be linked by the pairing can be changed from one power tool to another power tool.

According to the tenth aspect, a single dust collector can be shared by and linked to a plurality of power tools, whereby the versatility of the dust collector can be increased.

### BRIEF DESCRIPTION OF THE DRAWINGS

FIG. 1 is a drawing that shows a first representative, non-limiting embodiment of a dust collector (backpack dust extractor or vacuum cleaner) according to the present teachings.

FIG. 2 is an oblique view of the dust collector of FIG. 1.

FIG. 3 is an oblique view of an operation unit of the first representative dust collector that is shown with a cover of a wireless communication unit in a closed position.

FIG. 4 is the same oblique view of the operation unit as FIG. 3, but the adapter of the wireless communication unit has been pulled out.

FIG. 5 is an overall perspective view of dust collectors according to second to ninth representative, non-limiting embodiments of the present teachings, in which a wireless communication unit is disposed on a main body or on a belt/harness of the dust collector.

### DETAILED DESCRIPTION OF EMBODIMENTS

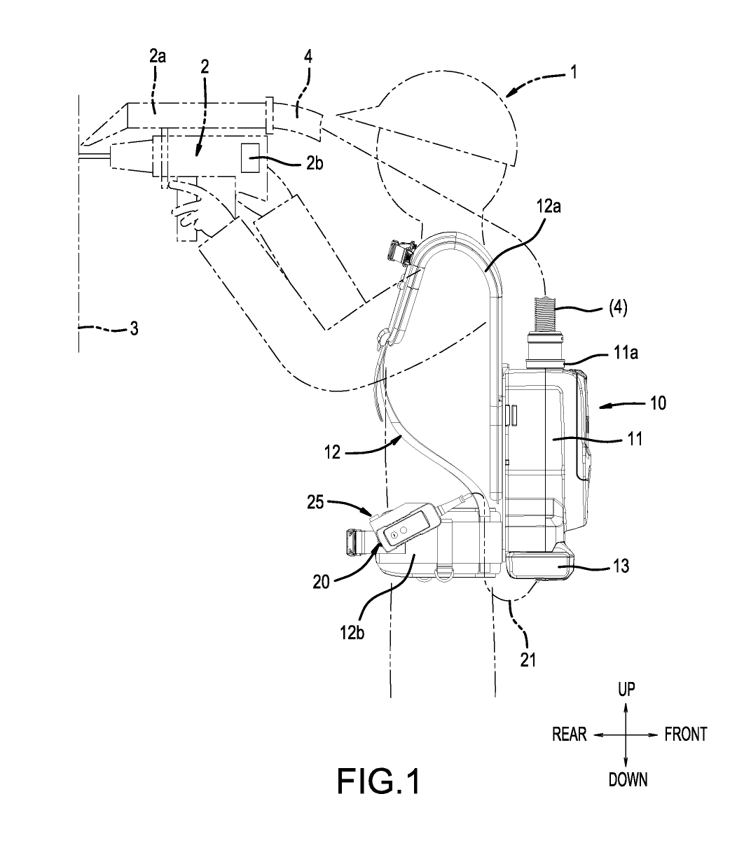

Representative, non-limiting embodiments of the present invention will now be explained with reference to FIGS. 1-5. As shown in FIG. 1, when a user 1, e.g., drills a hole into a concrete wall 3 using a handheld tool (drill) 2, dust, chips, etc. will be generated and can be immediately or simultaneously collected (suctioned, vacuumed) by a dust collector (cordless backpack dust extractor or vacuum cleaner) 10 according to the present teachings, thereby maintaining a clean work environment. The dust collectors 10 of the representative embodiments are configured to be carried on the user's back, i.e. so that the user 1 can operate the dust collector 10 by carrying it on his/her back. The handheld tool 2 has a tool accessory that generates dust, chips or other debris and may be, e.g., a hammer drill that drills holes in stone, concrete, or the like. A dust-collecting nozzle 2a of the dust collector 10 may be detachably mounted on the handheld tool 2. A tip (suction) part of the dust-collecting nozzle 2a is mounted so as to be directed towards the dust-generating area and the opposite end of the dust-collecting nozzle 2a is connected to a first end of a dust-collecting hose 4. The second (other) end of the dust-collecting hose 4 is connected to the dust collector 10. When the dust collector 10 is started, dust generated at the drilled area is immediately (simultaneously) collected (suctioned) by the dust-collecting nozzle 2a and stored within the dust collector 10 (for subsequent disposal), thereby preventing the dust from scattering to the surroundings.

A tool wireless-communication device 2b is provided on or in the handheld tool 2. Start and stop signals respectively corresponding to the start and stop of the handheld tool 2 are wirelessly transmitted from the tool wireless-communication device 2b to the dust collector 10 (more particularly, to a wireless communication unit 25, which will be further described below). A (not shown) trigger-type switch lever, which the user 1 operates by pulling (squeezing) with his/her fingertip, is provided on the handheld tool 2. When the switch lever (trigger) is pulled and the handheld tool 2 is started, a startup signal is transmitted from the tool wireless-communication device 2b to the dust collector 10. When the switch lever (trigger) is released to stop the operation of the handheld tool 2, a stop signal is transmitted from the tool wireless-communication device 2b to the dust collector 10. As will be further described below, if the dust collector 10 is in a wireless mode, then the starting and stopping of the dust collector 10 is linked to the starting and stopping of the handheld tool 2. The starting of the dust collector 10 may be set to occur simultaneously with the starting of the handheld tool 2 or shortly before (e.g., between 0.1-3 seconds before) or shortly thereafter (e.g., between 0.1-3 seconds after). On the other hand, for stopping the dust collector 10, a timer may be set (started) when the handheld tool 2 is stopped (e.g., the trigger is released) such that stoppage of the dust collector 10 occurs after the elapse of a set time period from when the operation of the handheld tool 2 stopped (i.e. after the trigger switch lever was released). In this case, after the handheld tool 2 has stopped, the dust collector 10 continues to operate for the set time period, to continue collecting any remaining dust around the tip of the handheld tool 2 (i.e. wherever the user points the tip (suction opening) of the dust-collecting nozzle 2a while the dust collector 10 is still suctioning). The set time period may be factory-set (i.e. not changeable) or user-changeable and may be, e.g., any time period between 0.1-10 seconds.

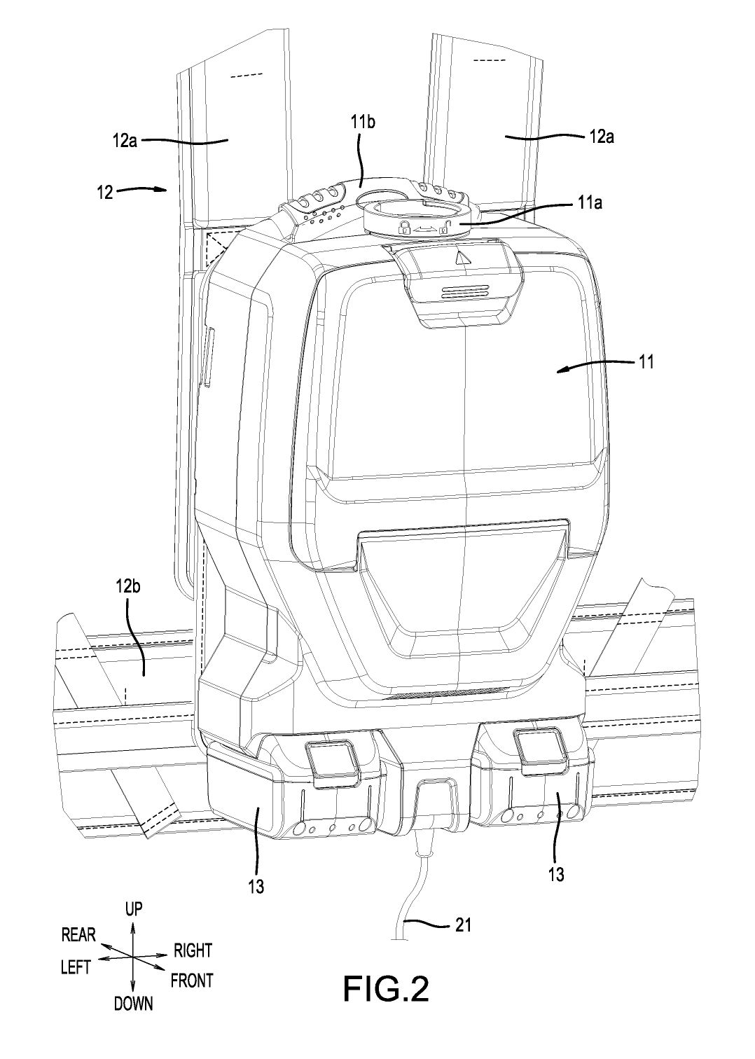

The dust collector 10 of the first embodiment of the present teachings comprises a main body 11, a belt or harness 12 configured for carrying the main body 11 on one's back, and a rectangular box-shaped operation unit (a remote control) 20 that can be manually operated by placing it in the palm of one's hand. A (not shown) dust-collecting mechanism is disposed in the interior of the main body 11. The dust-collecting mechanism (vacuum unit) may comprise, e.g., a fan (e.g., a centrifugal fan) or impeller that is rotated by an electric motor to suction air (and dust, etc., therewith) into a dust collection receptacle (e.g., drum, canister, bag, filter, etc.) of the dust-collecting mechanism, although the configuration of the dust-collecting mechanism is not particularly limited in the present teachings. For example, the dust-collecting mechanism may incorporate a cyclonic separator and/or a HEPA (high efficiency particulate air) filter. A hose-connection port 11a for connecting to the dust-collecting hose 4 is provided on an upper part of the main body 11. A grip 11b (see FIG. 2) for carrying the dust collector 10 by hand (i.e. when it is not being carried on one's back) is provided rearward of the hose-connection port 11a.

Still referring to FIGS. 1 and 2, two rechargeable battery packs (battery cartridges) 13 are detachably mounted on a lower part of the main body 11. Electric current (power) is supplied from the two battery packs 13 to the electric motor of the dust-collecting mechanism, as well as, e.g., to a light, the operation unit, a controller, etc. Highly versatile lithium-ion batteries are preferably used in the two battery packs 13, because they can be used also as the power supply of other power tools, such as the handheld tool 2. The two battery packs 13 can be used repeatedly by being removed and charged using a battery charger.

The belt or harness 12 comprises a pair of left and right shoulder belts (straps) 12a and a hip (waist) belt 12b. The user 1 can carry the main body 11 on his/her back by putting the shoulder belts 12a on (over) his/her left and right shoulders and fastening the hip belt 12b around his/her hips/waist.

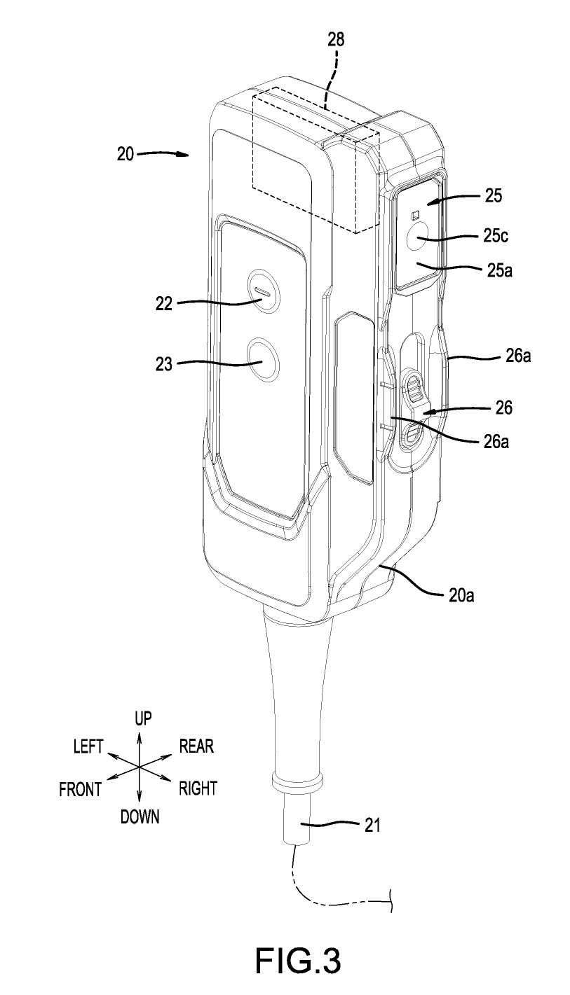

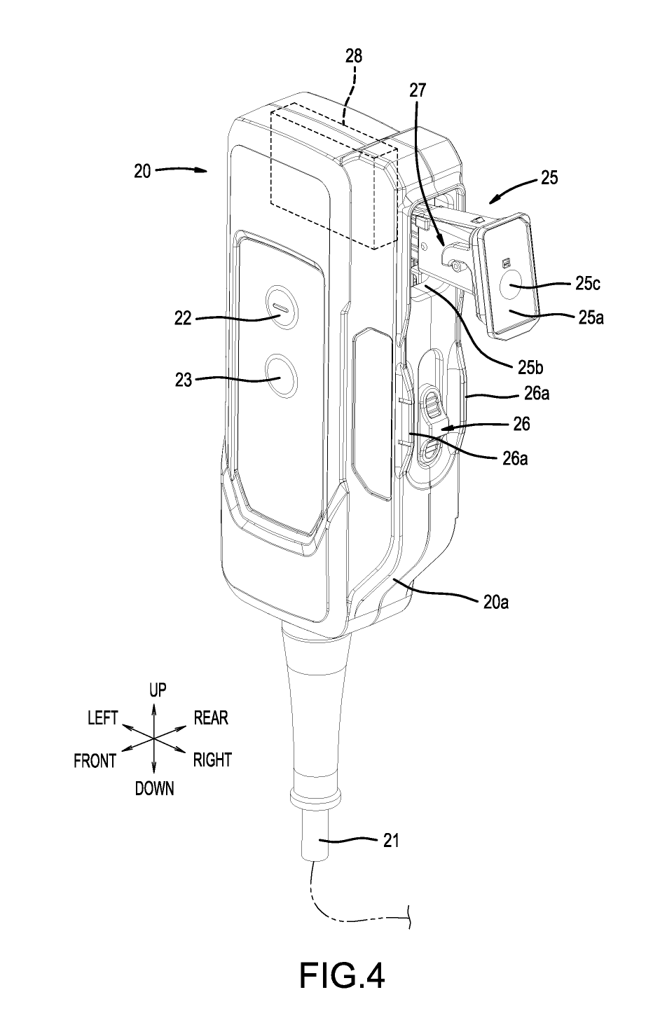

To make manual operation for starting and stopping the main body 11 comfortable and convenient, the operation unit (remote control or push button power selection controller) 20 is connected to the main body 11 via an electrical cord (electrical cable) 21. The user 1 can manually start and stop the main body 11 (i.e. the dust-collecting mechanism or vacuum unit therein) by operating (manipulating) the operation unit 20 (e.g., by pressing one or more buttons on the operation unit 20) so it is not necessary to operate (press) any switches (buttons) located on the main body 11, which is not visible to the user when carried on the user's back. Therefore, it is not necessary to reach around to the back side and fumble around to operate switches, buttons, etc. As shown in FIGS. 3 and 4, pushbutton-type operation switches 22, 23 for starting and stopping the dust-collecting mechanism (vacuum unit) contained in the main body 11 are disposed on a front surface of the operation unit (remote control) 20. When the start operation switch 22 is pressed, the electric motor of the dust-collecting mechanism starts and dust collection (suctioning, vacuuming) via the dust-collecting nozzle 2a is started. When the stop operation switch 23 is pressed, the electric motor stops and dust collection via the dust-collecting nozzle 2a is stopped either immediately or after elapse of a set time period. Optionally, the operation unit 20 may include one or more buttons or switches for manually setting/inputting this set time period, i.e. the time period that the dust collector 10 continues to operate (suction) after the trigger of the tool 2 has been released (i.e. after operation of the tool 2 has ceased). Further optionally, the operation unit 20 may include a display, e.g., LED, LCD, one or more lights, etc., that shows the current set time period and/or the suction fan rotational speed and/or the operating status of the dust collector 10.

A wireless communication unit 25 and a mode-changing switch 26 are provided on a right side part (one longitudinal side that intersects the front side) of the operation unit 20. The wireless communication unit 25 comprises an adapter 27 for wireless communication, such as a Bluetooth® adapter (dongle, card, etc.) that is insertable into a slot (recess) 25b. A cap (cover, lid) 25a closes up (covers) the slot 25b. As shown in FIG. 3, the adapter 27 is housed inside the slot 25b with the cap 25a closed to prevent dust, moisture, etc. from entering into the interior of the operation unit 20. When the adapter 27 is housed in the slot 25b, the adapter 27 is electrically connected to a controller 28 for wireless communication, which is built into the operation unit 20. As shown in FIG. 4, when the cap 25a is pulled to the near side and the slot 25b is opened, the adapter 27 can be pulled out of the slot 25b together with the cap 25a. When the adapter 27 is completely pulled out of the slot 25b, the adapter 27 is removed (detached) from the controller 28 for wireless communication.

Wireless communication, e.g., radio communication in accordance with a short-range, wireless communication standard (e.g., Bluetooth®), is performed between the wireless communication unit 25 of the operation unit 20 and the tool wireless-communication device 2b of the handheld tool 2. When a setup button 25c, which is provided on the cap 25a, is pressed-and-held, the wireless-communication part 25 of the operation unit 20 pairs (links) with the tool wireless-communication device 2b of the handheld tool 2 that serves as a target to be linked. In the paired state, the pairing can be cancelled by pressing-and-holding the setup button 25c. The same type of adapter (wireless communication module) may be used in the wireless communication unit 25 of the operation unit 20 and the tool wireless-communication device 2b of the handheld tool 2. Device registration is performed when the same types of adapters are attached. The registered adapter then can be used by plugging it into other corresponding power tools (i.e. a different target to be linked, for example, a hand-held cutting tool).

The slidable mode-changing switch 26 can be switched (slid) to a wireless mode, in which wireless communication is enabled, or to a manual mode, in which the operation unit 20 can be manually operated (i.e. wireless communication is disabled). Ribs 26a are provided on both a front-surface side and a rear-surface side of the mode-changing switch 26 to prevent (block) unintended operation of the operating unit 20. Both of the ribs 26a project out rightward from the right-side part of the operation unit 20, and the projection height of the ribs 26a is greater than the height of the mode-changing switch 26. Owing to the ribs 26a, interference of the mode-changing switch 26 with other items is avoided, thereby preventing inadvertent operation (sliding) of the mode-changing switch 26. It is noted that the spacing between the ribs 26a is set sufficiently large enough for the user to insert his/her fingertip therein and slide the mode-changing switch 26 up or down.

When the mode-changing switch 26 is slid to the upper side and operation is thereby switched to the wireless mode, the starting and stopping of the handheld tool 2 and the starting and stopping of the main body 11 (i.e. the dust-collecting mechanism therein) are linked by wireless communication via the tool wireless-communication device 2b and the wireless communication unit 25. When the mode-changing switch 26 is slid to the lower side and operation is thereby switched to the manual mode, the starting and stopping of the dust-collection mechanism (vacuum unit) of the main body 11 is performed by pressing the start/stop operation switches (buttons) 22, 23. Thus, when wireless communication between the handheld tool 2 and the operation unit 20 is disabled, the handheld tool 2 may be started and stopped independently of the starting and stopping of the dust-collection mechanism (vacuum unit) of the main body 11.

The operation unit 20 has a box shape that is elongated in the up-down direction and has a shape and size that is easy to be grasped with one hand. A corner part (i.e. the lower side corner portion of the right side portion which becomes the front side when held by the user) below the mode-changing switch 26 is omitted, and thereby an inclined part 20a is formed. The user 1 can easily place, e.g., the fingertip of his/her little (pinky) finger on the inclined part 20a. By bringing the tip of the little finger or the like into contact with the inclined part 20a, the user 1 can comfortably grasp the operation unit 20; as a result, secure gripability of the operation unit 20 is ensured. In addition, by providing the inclined part 20a only on one side, the user 1 can promptly distinguish the front surface and the rear surface of the operation unit 20 solely by feel/touch, i.e. without having to see the operation unit 20; as a result, ease of operation of the operation unit 20 is improved.

According to the dust collector 10 of the first embodiment configured as described above, the main body 11 (i.e. the dust-collecting mechanism therein) can be started and stopped in a linked or paired manner with the handheld tool 2 by the wireless communication unit 25, which is provided on or in the operation unit 20. In the wireless mode, the user 1 is not required to separately (additionally) start and stop the dust-collection mechanism (vacuum unit) of the main body 11, thereby improving ease of operation and work efficiency while using the dust collector 10.

In addition, because the wireless communication unit 25 is provided on the operation unit 20, which can be grasped by one hand, the user 1 can easily insert and remove the adapter 27, pair the handheld tool 1 and the dust collector 10, etc. while the main body 11 remains on his/her back. In addition, because the wireless communication unit 25 is provided on the operation unit 20, it is remote (isolated) from the main body 11, which tends to generate relatively strong vibration while the dust-collecting mechanism is operating. Therefore, chattering of the adapter 27 (i.e. rattling of the adapter 27 in its slot 25b) can be prevented, thereby ensuring that wireless communication can be performed reliably.

Furthermore, by compactly disposing the wireless communication unit 25 and the mode-changing switch 26 on the right-side part of the operation unit 20, the user 1 can comfortably and conveniently operate (manipulate) the wireless communication unit 25, the mode-changing switch 26, etc. using a fingertip of the same hand that is grasping the operation unit 20. This feature is useful, because the user may be holding the handheld tool 2 in the other hand.

In addition, the dust collector 10 can be linked or paired with another handheld tool 2 by once again performing the pairing operation using the setup button 25c. Consequently, the present embodiment is not limited to the illustrated hammer drill; for example, the dust-collector 10 can be coupled to, e.g., a disc grinder, a cutting tool such as a circular saw, or the like. Moreover, the present embodiment is not limited to handheld tools 2; for example, the dust collector 10 can be coupled to, e.g., larger cutting or processing machines (i.e. so-called “benchtop” tools) that are not handheld during operation, such as a table saw, a miter saw, etc., by pairing the wireless communication unit 25 of the dust collector 10 with the tool wireless-communication device 2b of the tool 2.

Furthermore, the adapter 27 can be removed from the wireless communication unit 25 and deployed for use in the wireless communication unit of another tool. However, it should be understood that the adapter 27 (wireless communication module or card) may instead be permanently (non-removably) disposed in the operation unit 20 in other embodiments of the present teachings.

Various modifications can be added to the first embodiment explained above. For example, although a cordless-type dust collector 10, in which the battery packs 13 serve as the power supply, was described above and depicted in FIGS. 1-4, the same wireless communication unit 25 can be used even with a dust collector in which 100-220 VAC mains power serves as the power supply, i.e. the dust collector 10 may be “corded”.

In addition, although the present embodiment illustrates a configuration in which, by providing the wireless communication unit 25 on the operation unit 20, problems such as chattering are prevented while ease of operation is increased, the present embodiment can also be modified to instead provide the wireless communication unit for linking/pairing with the handheld tool 2 on the main body 11, as will be described further below. In such an embodiment as well, despite the fact that ease of operation, etc. of the wireless communication unit decreases, the ease of operation and the work performance of the dust collector can be increased; in this regard, the same functions and effects can be obtained.

Furthermore, the wire communication standard/protocol is not limited to the above-described short-range wireless communication; for example, other wireless-communication standards, e.g., near field communication (NFC) or even WiFi, can be used.

In addition, although a corded operation unit 20 that is connected by the electrical cord 21 to the main body 11 was described above, the illustrated wireless communication unit also can be used with a cordless operation unit (cordless remote control) that performs wireless communication with the main body 11. That is, signal communication between the main body 11 and the wireless communication unit 25 (e.g., a cordless operation unit 20) may be performed wirelessly, e.g., using Bluetooth® or another wireless communication protocol.

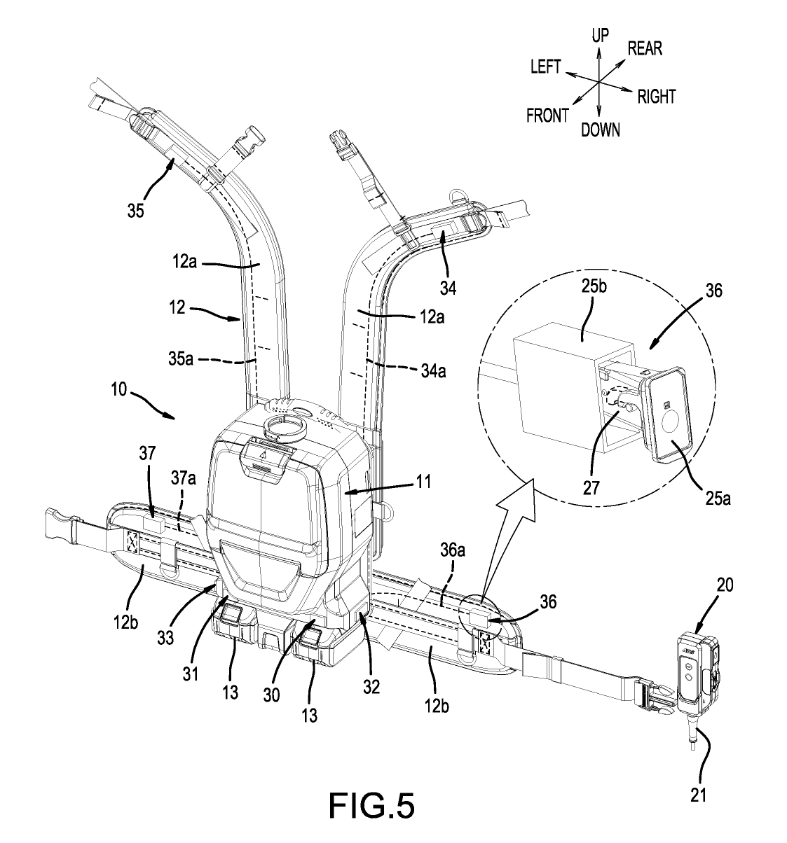

The second to ninth representative embodiments of the present teachings are exemplified in FIG. 5, in which wireless communication units 30-37 are respectively provided on the main body 11 or on the belt (harness) 12 at locations other than the operation unit 20. That is, the location of the wireless communication unit (i.e. one of units 30-37) on the dust collector 10 differs from the first embodiment. Each of the wireless communication units 30-37 of the second to ninth embodiments includes the slot 25b for accommodating the adapter 27 and the cap 25a, similar to the first embodiment. For all other parts that are not changed, the same reference numerals as the first embodiment are used. It is noted that, although eight different locations for placing the wireless communication unit 30-37 are shown in FIG. 5, only one wireless communication unit is required for any particular embodiment. Thus, FIG. 5 should be understood as compactly illustrating eight different alternative locations for placing the wireless communication unit and each location is denoted with a different reference number (i.e. one of 30-37).

More specifically, the wireless communication unit 30 of the second embodiment of the present teachings is placed on the front, lower, right side of the main body 11. In the alternative, the wireless communication unit 31 of the third embodiment of the present teachings is placed on the front, lower, left side of the main body 11. In another alternative, the wireless communication unit 32 of the fourth embodiment of the present teachings is placed on the lateral, lower, right side of the main body 11. In a further alternative, the wireless communication unit 33 of the fifth embodiment of the present teachings is placed on the lateral, lower, left side of the main body 11.

With regard to the wireless communication units 30-33 of the second to fifth embodiments, the slot 25b is defined within the main body 11. Therefore, when the cap 25a closes the slot 25b, the cap 25a becomes substantially flush with the outer surface of the main body 11 and the wireless communication units 30-33 are respectively inserted such that they do not protrude outward of the outer surface of the main body 11.

In the second to fifth embodiments, each wireless communication unit 30-33 is disposed at or near the lower side of the main body 11 at a position where the user can reach with his/her hand while carrying the dust collector 10 on his/her back. Therefore, the user can easily remove the adapter 27 while the dust collector 10 is mounted on the shoulders, such that an ergonomic (easily reachable) location is provided for the wireless communication unit 30-33.

In further embodiments of the present teachings, the wireless communication unit 34-37 may be disposed on the belt (harness) 12 instead of on the operating unit 20 or on the main body 11. In this regard, FIG. 5 also shows a sixth embodiment in which the wireless communication unit 34 is disposed on the distal end side of the right shoulder belt 12a. Alternately, FIG. 5 also shows a seventh embodiment in which the wireless communication unit 35 is disposed on the distal end side of the left shoulder belt 12a. Because the distal ends of the shoulder belts 12a are attached to the hip (waist) belt 12b when the dust collector 10 is being carried on the user's back, the wireless communication unit 34, 35 will be located at the hip (waist) level of the front side of the user during operation, thereby providing additional ergonomic locations for reaching the adapter 27 during operation.

In an eighth embodiment of the present teachings, the wireless communication unit 36 may be disposed on the right distal end portion of the hip belt 12b. Alternatively, the wireless communication unit 37 may instead be disposed on the left distal side portion of the hip belt 12b (ninth embodiment). If the wireless communication unit 36, 37 is disposed on a distal end portion of the hip belt 12b, the wireless communication unit 36, 37 will again be located at the hip (waist) level of the front or lateral side of the user during operation, thereby providing additional ergonomic locations for reaching the adapter 27 during operation.

The wireless communication units 34-37 of the sixth to ninth embodiments are each disposed on the front or outer side of the belt 12a or 12b, which is opposite to the side of the belt 12a or 12b that contacts (rests against) the shoulder and waist of the user. The wiring 34a-37a for each of the wireless communication units 34-37 preferably extends within the shoulder belt 12a or the hip belt 12b, respectively, i.e. between two fabric portions that serve as the interior and exterior sides of the shoulder belt 12a or the hip belt 12b, such that the wiring 34a-37a is protected from external influences.

If the wireless communication units 34-37 are disposed on the belt (harness) 12 in the vicinity of the user's waist during operation, the user can easily reach the wireless communication unit 34-37 while carrying the dust collector 10 on his/her back, thereby providing ergonomic locations for mounting the adapter 27. Of course, substantially the same operation and effects can be achieved even if the wireless communication unit is disposed in the vicinity of the shoulder or the chest near an end portion or a central portion of the shoulder belt 12a.

Naturally, each of the embodiments described above may be further modified within the scope of the present teachings. For example, although a cordless dust collector 10 using rechargeable battery packs 13 as its power source was disclosed above, the respective wireless communication units 25, 30-37 also can be utilized in a corded dust collector powered by a commercial AC power supply of 100-240 V.

Furthermore, in the second to fifth embodiments, the wireless communication units 30 to 33 are provided on the main body 11 and, in the sixth to ninth embodiments, the wireless communication units 34-37 are provided on the belt/harness 12. Therefore, the operation unit 20 may be omitted, if desired. In such embodiments, manually operable switches, buttons, etc. may be provided on the main body 11 and/or on the belt 12 and/or on the wireless communication unit 30-37 for inputting commands such as mode switching, startup, stop in manual mode, changing the set time period that the dust collector 10 continues to operate after operation of the tool 2 has ceased, etc.

In another alternative embodiment of the present teachings, the wireless communication between the tool 2 and dust collector 10 and/or between the user and the dust collector 10 may be implemented via an “app” on a mobile device, such as a smartphone, tablet, wristwatch, head-mounted device or any other type of wearable device. In such an embodiment, commands for starting and stopping the dust collector 10, changing the suction force (fan rotational speed), etc., can be transmitted to the main body 11 by inputting the instructions using the app, e.g., by touching a touchscreen or by giving audible commands (i.e. by speaking terms such as “vacuum start”, “vacuum stop”, “speed up”, “speed down”, etc.) that are input to the app stored on the mobile device. The instructions are then processed in the mobile device and a wireless command is transmitted from the mobile device to the main body 11. In addition or in the alternative, the app may be configured to communicate with the tool wireless-communication device 2b in order to relay information, commands, etc. from the tool 2 to the dust collector 10. The app may also provide a screen, button, etc. for changing the set time period that the dust collector 10 continues to operate (suction) after operation of the tool 2 has stopped.

In addition or in the alternative, the dust collector 10 may include an audio or sound sensor that senses one or more characteristic sounds of a rotating motor, e.g., of a drill, saw, etc., and automatically starts the vacuum unit of the dust collector 10 upon sensing the characteristic sound(s) (which may be audible or inaudible to humans) and automatically stops the vacuum unit of the dust collector 10 upon sensing a cessation of the characteristic sound(s). In such an embodiment, the tool wireless-communication device 2b optionally may be omitted. In another alternate embodiment, the sound sensor may be the microphone of a mobile device (e.g., a smartphone, wrist watch, head-mounted computer, etc.) that detects the startup or stopping of the motor of the tool 2 based upon characteristic motor sound(s) and wirelessly outputs (communicates) startup and stop commands to the dust collector 10.

In a further embodiment of the present teachings, the tool wireless-communication device 2b and the wireless communication unit 25, 30-37 may be replaced by an electric cable that extends from the tool 2 to the dust collector 10 and communicates signals, such as start and stop signals, from the tool 2 to the dust collector 10, and vice versa if necessary. For example, such an embodiment may be implemented by including an electrical connector, such as a USB connector (e.g., USB, mini-USB, micro-USB, etc.), in the mechanical connector (retainer) that physically connects (mounts) the dust-collecting nozzle 2a to (on) the tool 2 and in the mechanical connector that physically connects (mounts) the dust-collecting hose 4 to the main body 11, e.g., to the hose-connecting port 11a. The electrical cable that electrically connects the two electrical connectors may then be run through the interior of the dust-collecting hose 4 or along the exterior surface of the dust-collecting hose 4. In this type of wired embodiment, when the dust-collecting nozzle 2a is mounted on the tool 2 and the dust-collecting hose 4 is inserted into the hose-connecting port 11a (which may include the electrical connector mate for the electrical connector on the end of the dust-collecting hose 4), the electrical communication path between the tool 2 and the dust collector 10 is simultaneously established, whereby start/stop commands can be communicated via a wired connection from the tool 2 to the dust collector 10.

In addition, although a hammer drill was exemplified above as an electric power tool (target to be linked/paired) that is linked/paired with the dust collector 10 for starting and stopping, other drilling tools may serve as the target to be linked/paired. In addition, the present dust collectors 10 may be utilized with hand-held cutting tools such as circular saws, chain saws, etc., or any other types of tools that generate dust (e.g., sawdust, concrete dust, etc.) or other chips (e.g., wood chips, metal chips, stone chips, etc.), such as grinders, sanders, routers, etc. Moreover, the present dust collectors 10 are not limited to hand-held tools, and can be widely with stationary or “benchtop” electric power tools, such as table saws, miters, planers, etc.

Furthermore, with regard to the wireless communication standards/protocols that may be implemented in any of the above-mentioned electric power tools (linked tools) and or above-mentioned dust collectors, other types of wireless communication standards/protocols may be utilized and the present teachings are not limited to the above-described short-range wireless communication protocols and standards. In addition to Bluetooth®, ANT+®, WiFi, DASH7, etc., are representative, non-limiting examples of wireless communication standards that may be utilized with the present teachings. One or both of the tool wireless-communication device 2b and the wireless communication device 25, 30-37 of the dust collector 10 may be embodied, e.g., in the form of a wireless card or circuit board, which may be removably or permanently mounted in or on the tool or dust collector, a wireless dongle, a wireless USB adapter, etc.

Additional embodiments disclosed herein include, but are not limited to:

1. A dust collector comprising:

a main-body part, wherein one end of a dust-collecting hose is connected thereto and the other end is connected to a power tool;

a back-carrying belt for the purpose of a user to carry the main-body part on his/her back; and

an operation unit for remotely operating the main-body part;

wherein starting and stopping of the main-body part is linked, by wireless communication, to starting and stopping of the power tool.

2. The dust collector according to the above embodiment 1, wherein an adapter for performing wireless communication is provided on the operation unit.

3. The dust collector according to the above embodiment 2, wherein:

the operation unit has a rectangular-box shape and comprises, on its front surface, operation switches for starting and stopping the main-body part; and

the wireless-communication adapter is built into a side part that intersects the front surface in a longitudinal direction.

4. The dust collector according to the above embodiment 3, wherein:

the operation unit has a rectangular-box shape and can be operated by placing the operation unit on one's palm; and

a corner part on a near side of a side part, in which the wireless-communication adapter is built in, is omitted.

5. The dust collector according to the above embodiment 1, wherein an adapter for performing wireless communication is provided on the main-body part.

6. The dust collector according to any one of the above embodiments 1-5, wherein the operation unit is connected to the main-body part via a cord for communication.

7. The dust collector according to any one of the above embodiments 1-6, wherein the target to be linked by the pairing can be changed from the power tool to another power tool.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved dust collectors (backpack dust extractors or vacuum cleaners) for use with power tools.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the processing unit, is also understood as a corresponding method step or as a feature of a method step. In an analogous manner, aspects which have been described in the context of or as a method step also represent a description of a corresponding block or detail or feature of a corresponding device, such as the processing unit.

Depending on certain implementation requirements, exemplary embodiments of the controller 28 of the operation unit or any other controller for the dust-collection mechanism or the tool of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the controller, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

The terms “dust collector”, “dust collector system”, “dust extractor”, “vacuum”, “vacuum cleaner” are intended to be interchangeable unless specifically indicated otherwise. Also, it is noted that, although the dust-collecting nozzle 2a of the disclosed embodiments is arranged parallel and adjacent to the tool accessory, the dust-collecting nozzle 2a also may be configured to entirely surround the tool accessory, in order to further limit the amount of dust, chips, debris, etc. that can escape to the work environment.

### EXPLANATION OF THE REFERENCE NUMBERS

1 User
2 Handheld tool
2a Dust-collecting nozzle
2b Tool wireless-communication device
3 Concrete wall
4 Dust-collecting hose
10 Dust collector (backpack dust extractor or vacuum cleaner)
11 Main body of dust collector
11a Hose-connection port
11b Grip
12 Belt (Harness)
12a Shoulder belt
12b Hip (waist) belt
13 Battery pack
20 Operation unit (remote control)
20a Inclined part
21 Electrical cord (cable)
22 Operation switch (for starting)
23 Operation switch (for stopping)
25 Wireless communication unit (first embodiment)
25a Cap
25b Slot
25c Setup button
26 Mode-changing switch
26a Rib
27 Adapter (for wireless communication)
28 Controller (for wireless communication)
30-37 Wireless communication unit (second to ninth embodiments)
34a-37a Wiring for wireless communication unit (sixth to ninth embodiments)

We claim:

1. A backpack dust extractor comprising:
a main body;
a dust-collecting mechanism housed in the main body;
a dust-collecting hose having a first end connected to the main body and a second end that is attachable to a power tool;
a belt or harness attached to the main body and being configured to carry the main body on a user's back; and
a wireless communication unit configured to transmit commands for starting and stopping the dust-collecting mechanism, via wireless communication, in conjunction with starting and stopping of the power tool.

2. The backpack dust extractor according to claim 1, wherein the wireless communication unit is provided on a lower portion of the main body.

3. The backpack dust extractor according to claim 2, wherein the wireless communication unit is provided on a front side or lateral side of the main body.

4. The backpack dust extractor according to claim 1, wherein the wireless communication unit is provided on the belt or harness.

5. The backpack dust extractor according to claim 4, wherein the wireless communication unit is provided on a shoulder belt or hip belt of the belt or harness.

6. The backpack dust extractor according to claim 1, further comprising:
an operation unit configured to manually input commands for controlling the dust-collecting mechanism.

7. The backpack dust extractor according to claim 6, wherein the operation unit has a rectangular-box shape and comprises, on its front surface, operation switches for starting and stopping the dust-collecting mechanism.

8. The backpack dust extractor according to claim 7, wherein:
the wireless communication unit is provided in or on the operation unit, and
a wireless communication adapter is provided on or in the wireless communication unit.

9. The backpack dust extractor according to claim 8, wherein:
the adapter is disposed in a side part of the operation unit that intersects the front surface in a longitudinal direction.

10. The backpack dust extractor according to claim 9, wherein:
the operation unit is configured to be held on one's palm; and
a curved corner shaped to receive a pinky finger is formed in the side part of the operation unit that receives the adapter adjacent a mode-changing switch.

11. The backpack dust extractor according to claim 10, wherein the operation unit is connected to the main body via an electric cable for signal communication.

12. The backpack dust extractor according to claim 6, wherein the operation unit is connected to the main body via an electric cable for signal communication.

13. The backpack dust extractor according to claim 12, wherein the operation unit has a rectangular-box shape and comprises operation switches for manually inputting start and stop commands to the dust-collecting mechanism.

14. The backpack dust extractor according to claim 13, wherein the wireless communication unit is provided on a lower portion of the main body.

15. The backpack dust extractor according to claim 13, wherein the wireless communication unit is provided on a shoulder belt or hip belt of the belt or harness.

16. The backpack dust extractor according to claim 1, wherein the target to be linked by the pairing can be changed from the power tool to another power tool.

17. A power tool system comprising:
a power tool having a tool accessory and a tool wireless-communication device configured to wirelessly transmit signals indicating that operation of the power tool has started and stopped; and
the backpack dust extractor according to claim 1,
wherein the second end of the dust-collection hose or a dust-collecting nozzle connected thereto is attached to the power tool so that a suction opening is proximal to the tool accessory, and
the wireless communication unit is paired with the tool wireless-communication device to receive the wirelessly-transmitted signals.

18. The power tool system according to claim 17, wherein the power tool is selected from the group consisting of a drill, a saw, a planar, a grinder, a sander or a planer.

19. A power tool system comprising:
a power tool having a tool accessory and a tool wireless-communication device configured to wirelessly transmit signals indicating that operation of the power tool has started and stopped; and
the backpack dust extractor according to claim 13,
wherein the second end of the dust-collection hose is attached to the power tool so that a suction opening is proximal to the tool accessory, and
the wireless communication unit is paired with the tool wireless-communication device to receive the wirelessly-transmitted signals.

20. The power tool system according to claim 19, wherein the power tool is selected from the group consisting of a drill, a saw, a planar, a grinder, a sander or a planer.
